(19) United States
(12) Patent Application Publication
(10) Pub. No.: US 2026/0061493 A1
(43) Pub. Date: Mar. 5, 2026

(54) ADVANCED CRACK HEALING OF METAL PARTS

(71) Applicant: Beehive Industries, LLC, Centennial, CO (US)

(72) Inventors: Shawn M. KELLY, Huntersville, NC (US); Michael J. WEIMER, Englewood, CO (US)

(21) Appl. No.: 19/383,199

(22) Filed: Nov. 7, 2025

Related U.S. Application Data
(63) Continuation of application No. PCT/US2024/062129, filed on Dec. 27, 2024.
(60) Provisional application No. 63/615,215, filed on Dec. 27, 2023.

(51) Int. Cl. B22F 10/64; B22F 10/62; B33Y 80/00

(52) U.S. Cl. CPC B22F 10/64; B22F 10/62; B33Y 80/00

(57) ABSTRACT

A method for treating a part in order to heal cracks, includes bringing surfaces of at least one crack in a part into contact with one another at at least one contact point, expanding the contact of the at least one contact point associated with the at least one crack and applying hot isostatic pressure to the part.

### CROSS-REFERENCE TO RELATED PATENT APPLICATIONS

This patent application is a continuation of, and claims the benefit of, International Application No. PCT/US24/062129, filed in the United States Receiving Office on Dec. 27, 2024.

This patent application and International Application No. PCT/US24/062129 claim the priority and benefit under 35 U.S.C. § 119(e) of U.S. Provisional Patent Application Ser. No. 63/615,215 filed Dec. 27, 2023, entitled “ADVANCED CRACK HEALING OF METAL PARTS.” U.S. Provisional Patent Application Ser. No. 63/615,215 is herein incorporated by reference in its entirety.

### TECHNICAL FIELD

Embodiments are generally related to metallurgy. Embodiments are related to manufacturing methods and processes. Embodiments are related to additive manufacturing methods and processes. Embodiments are further related to heat treatments of metal parts. Embodiments are directed to heat treatment processes to heal cracks in metal parts.

### BACKGROUND

Casting and additive manufacturing of difficult to cast or weld alloys often result in microcracking in the part. This is driven by the high thermal stresses the part experiences, a solidifying microstructure, and decreased strength at elevated temperatures.

In some prior art approaches, microcracking is addressed by reducing the thermal gradients, changing printing or casting parameters, and/or changing alloy chemistry. For components with internal cracking, isostatic pressure can be used to create contact between opposing faces of the crack. At appropriate temperatures, diffusion between opposite sides of the crack or pore occurs resulting in a bond and “crack healing.”

Hot isostatic pressure (HIP) alone is a reasonable method to heal cracks when the cracks are not surface connected (i.e., internal cracking). However, when the cracks are open to the surface, the isostatic pressure now acts on the crack's surface itself, effectively opening the crack, not allowing contact between apposing faces of the crack, and consequently preventing full part healing. Under such circumstances HIP is not sufficient to heal cracks in the bulk of a part when there is a high degree of microcracking that is connected to the surface.

Although there are various approaches for healing surface connected cracks, prior art approaches generally do not solve the fundamental problem, because most rely on HIP as the main driver of surface contact.

Accordingly, there is a need in the art for methods and processes for healing cracks in metal parts, as disclosed in the embodiments herein.

### BRIEF SUMMARY

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

It is, therefore, one aspect of the disclosed embodiments to treat workpieces, products, or parts.

It is another aspect of the disclosed embodiments to cure defects in metal parts.

It is another aspect of the disclosed embodiments to cure defects in parts by bringing crack surfaces together.

For example, a method for crack healing comprises bringing surfaces of at least one crack in a part into contact with one another at at least one contact point, expanding contact of the at least one contact point associated with the at least one crack, and applying hot isostatic pressure to the part.

In an embodiment, bringing surfaces of the at least one crack in a part into contact with one another at at least one contact point further comprises heating the part.

In an embodiment, bringing surfaces of the at least one crack in a part into contact with one another at at least one contact point further comprises heating the part at partial pressure.

In an embodiment, bringing surfaces of the at least one crack in a part into contact with one another at at least one contact point further comprises heating the part at partial pressure in a reactive gas.

In an embodiment, bringing surfaces of the at least one crack in a part into contact with one another at at least one contact point further comprises inducing at least one of oxidation, carburization, or nitriding on the part.

In an embodiment, bringing surfaces of the at least one crack in a part into contact with one another at at least one contact point further comprises applying a coating to the part. In an embodiment, applying a coating to the part comprises physical vapor deposition coating. In an embodiment, applying a coating to the part comprises thin film deposition coating. In an embodiment, applying a coating to the part comprises anodizing the part.

In an embodiment, bringing surfaces of the at least one crack in a part into contact with one another at at least one contact point further comprises directing stress fields at a surface of the part. In an embodiment, directing stress fields at a surface of the part comprises at least one of grit blasting, shot blasting, dry ice blasting, and laser shock processing.

In an embodiment, the method further comprises applying a final heat treatment to the part.

In an embodiment, a method comprises bringing surfaces of at least one crack in a part into contact with one another at at least one contact point, expanding contact of the at least one contact point associated with the at least one crack, and applying hot isostatic pressure to the part. In an embodiment, bringing surfaces of the at least one crack in a part into contact with one another at at least one contact point further comprises heating the part at partial pressure. In an embodiment, bringing surfaces of the at least one crack in a part into contact with one another at at least one contact point further comprises heating the part at partial pressure in a reactive gas. In an embodiment, bringing surfaces of the at least one crack in a part into contact with one another at at least one contact point further comprises inducing at least one of oxidation, carburization, or nitriding on the part. In an embodiment, bringing surfaces of the at least one crack in a part into contact with one another at at least one contact point further comprises applying a coating to the part. In an embodiment, applying a coating to the part comprises physical vapor deposition coating. In an embodiment, applying a coating to the part comprises thin film deposition coating. In an embodiment, applying a coating to the part comprises anodizing. In an embodiment, bringing surfaces of the at least one crack in a part into contact with one another at at least one contact point further comprises directing stress fields at a surface of the part. In an embodiment, directing stress fields at a surface of the part comprises at least one of grit blasting, shot blasting, dry ice blasting, laser shock processing, and burnishing. In an embodiment, the method comprises applying a final heat treatment to the part.

In an embodiment, a method for treating a part comprises introducing, to a furnace, a partial pressure of argon, with the part therein, ramping a temperature inside the furnace to at least 940° F., holding the temperature inside the furnace for at least 1 hour, ramping the temperature inside the furnace to at least 1247° F., holding the temperature inside the furnace for at least 1 hour, ramping the temperature inside the furnace to at least 2320° F., and reducing the temperature in the furnace. In an embodiment, the method for treating a part further comprises, ramping the temperature inside the furnace to at least 2320° F. and holding the temperature inside the furnace for at least 105 minutes. In an embodiment of the method for treating a part, ramping a temperature inside the furnace to at least 940° F., further comprises increasing the temperature inside the furnace at a rate of 10° F./min. In an embodiment of the method for treating a part, ramping the temperature inside the furnace to at least 1247° F., further comprises increasing the temperature inside the furnace at a rate of 10° F./min. In an embodiment of the method for treating a part, ramping the temperature inside the furnace to at least 2320° F., further comprises increasing the temperature inside the furnace at a rate of 10° F./min. In an embodiment of the method for treating a part, reducing the temperature in the furnace further comprises argon quenching at a rate of at least 135° F./min. In an embodiment of the method for treating a part, the partial pressure of argon comprises a partial pressure of argon of 500±200 mTorr. In an embodiment of the method for treating a part further comprises applying hot isostatic pressure to the part in the furnace.

In an embodiment, a method for treating a part comprises introducing, to a furnace, a partial pressure of argon, with the part therein, ramping a temperature inside the furnace to at least 940° F. at a rate of nominally 10° F./min, holding the temperature inside the furnace for at least 1 hour, ramping the temperature inside the furnace to at least 1232° F. 10° F./min, holding the temperature inside the furnace for at least 1 hour, ramping the temperature inside the furnace to at least 2320° F. 75° F./min, and reducing the temperature in the furnace.

### BRIEF DESCRIPTION OF THE DRAWINGS

The accompanying figures, in which like reference numerals refer to identical or functionally similar elements throughout the separate views and which are incorporated in and form a part of the specification, further illustrate the embodiments and, together with the detailed description, serve to explain the embodiments disclosed herein.

FIG. 1 depicts a method for heat treating a part to reduce cracking, in accordance with the disclosed embodiments;

FIG. 2A depicts a surface breaking crack in a part, in accordance with the disclosed embodiments;

FIG. 2B depicts a method of steps for healing a crack in a part, in accordance with the disclosed embodiments;

FIG. 3A depicts aspects of the method for bringing opposing crack faces of a crack in contact with one another, in accordance with the disclosed embodiments;

FIG. 3B depicts aspects of the method for bringing opposing crack faces of a crack in contact with one another, in accordance with the disclosed embodiments;

FIG. 3C depicts aspects of the method for bringing opposing crack faces of a crack in contact with one another, in accordance with the disclosed embodiments;

FIG. 3D depicts aspects of the method for bringing opposing crack faces of a crack in contact with one another, in accordance with the disclosed embodiments;

FIG. 3E depicts aspects of the method for bringing opposing crack faces of a crack in contact with one another, in accordance with the disclosed embodiments;

FIG. 4 depicts a first view of crack surfaces after a first method step and a second view of crack surfaces after a second method step, in accordance with the disclosed embodiments;

FIG. 5 depicts steps associated with a heat treatment cycle, in accordance with the disclosed embodiments;

FIG. 6 depicts steps associated with a heat treatment cycle method, in accordance with the disclosed embodiments; and

FIG. 7 depicts steps associated with a heat treatment cycle, in accordance with the disclosed embodiments.

### DETAILED DESCRIPTION

The particular values and configurations discussed in the following non-limiting examples can be varied and are cited merely to illustrate one or more embodiments and are not intended to limit the scope thereof.

Example embodiments will now be described more fully hereinafter with reference to the accompanying drawings, in which illustrative embodiments are shown. The embodiments disclosed herein can be embodied in many different forms and should not be construed as limited to the embodiments set forth herein; rather, these embodiments are provided so that this disclosure will be thorough and complete, and will fully convey the scope of the embodiments to those skilled in the art. Like numbers refer to like elements throughout.

The terminology used herein is for the purpose of describing particular embodiments only and is not intended to be limiting. As used herein, the singular forms “a”, “an”, and “the” are intended to include the plural forms as well, unless the context clearly indicates otherwise. It will be further understood that the terms “comprise” and/or “comprising,” when used in this specification, specify the presence of stated features, integers, steps, operations, elements, and/or components, but do not preclude the presence or addition of one or more other features, integers, steps, operations, elements, components, and/or groups thereof.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It is contemplated that any embodiment discussed in this specification can be implemented with respect to any method, kit, reagent, or composition of the invention, and vice versa. Furthermore, compositions of the invention can be used to achieve methods of the invention.

It will be understood that particular embodiments described herein are shown by way of illustration and not as limitations of the invention. The principal features of this invention can be employed in various embodiments without departing from the scope of the invention. Those skilled in the art will recognize or be able to ascertain using no more than routine experimentation, numerous equivalents to the specific procedures described herein. Such equivalents are considered to be within the scope of this invention and are covered by the claims.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit, and scope of the invention. All such similar substitutes and modifications apparent to those skilled in the art are deemed to be within the spirit, scope and concept of the invention as defined by the appended claims.

The embodiments disclosed herein are directed to processes and methods to heal cracks, such as process-induced cracks, in metal workpieces. As used herein, the term “workpiece” can refer to any fabricated metal part, component, device or the like. Embodiments may include processes and methods addressing the issue of obtaining contact of two opposing surface breaking crack faces to enable effective use of hot isostatic pressure (HIP) to heal cracking. In certain embodiments, the process can be applied to workpieces fabricated via additive manufacturing of nickel-based superalloys with high gamma prime phase. It should be appreciated that the methods disclosed herein could apply to any metal alloy part (produced by additive manufacturing, casting, welding, etc.) that experiences a degree of microcracking that becomes surface breaking. However, it should be appreciated that, in other embodiments, the processes and methods can be applied to other parts, fabricated using other techniques and made of other metal materials.

In certain embodiments, a workpiece can be produced by additive manufacturing (e.g., Laser Powder Bed Fusion (LPBF), or Electron Beam Powder Bed Fusion (EBPBF)) or other such manufacturing process. In certain cases, process parameters associated with the manufacturing process can be set so as to minimize, or totally eliminate, low aspect-ratio defects (such as lack of fusion, gas, key-hole porosity and macro-voids). The resulting component will preferably have defects primarily being cracks with a high aspect ratio and relatively small size. Embodiments can further include a heat treatment cycle. The heat treatment cycle may be used to “heal” and/or transform the high aspect ratio cracks into isolated pores via a prolonged solutionizing process. The heat treatment cycle generally comprises a relatively fast ramping of the temperature of the component to a temperature above the gamma prime solvus temperature (or other such material dependent temperature). In some embodiments, the heat treatment cycle can be completed under a vacuum, or at partial pressure such as an inert gas. Finally, hot isostatic pressing (HIP) can be applied to close the remaining isolated porosities. All the surface-ended cracks that have transformed into isolated porosities in the previous step are effectively closed via HIPing.

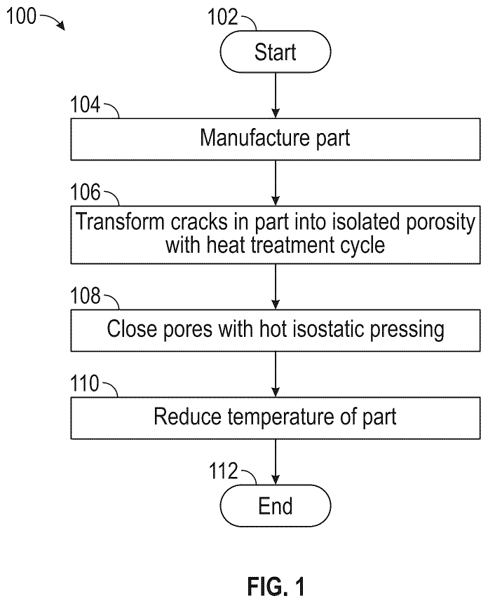

FIG. 1 provides a flow chart of steps associated with a method 100 for crack healing, in accordance with the disclosed embodiments. The method starts at 102.

At step 104, the workpiece can be manufactured. In certain embodiments, the workpiece can be manufactured using 3D printing techniques. This can include additive manufacturing such as Laser Powder Bed Fusion (LPBF), Electron Beam Powder Bed Fusion (EBPBF), direct energy deposition, powder metallurgy, welding, and/or casting. In other embodiments, other manufacturing processes using various types of metals or metal alloys can be used without departing from the scope of the embodiments.

Once the workpiece is manufactured, the cracks in the workpiece (primarily high aspect ratio cracks) can be transformed into isolated porosity in the workpiece, with a heat treatment cycle at step 106.

The method 100 proceeds to hot isostatic pressing at step 108, to close the pores formed during the heat treatment cycle. In an exemplary embodiment, hot isostatic pressing at step 108 comprises exposing the workpiece to a second heat treatment cycle at high pressure.

At step 110, the temperature and pressure of the environment surrounding the workpiece can be reduced after the pores in the workpiece are closed via the hot isostatic pressure. The method ends at step 112.

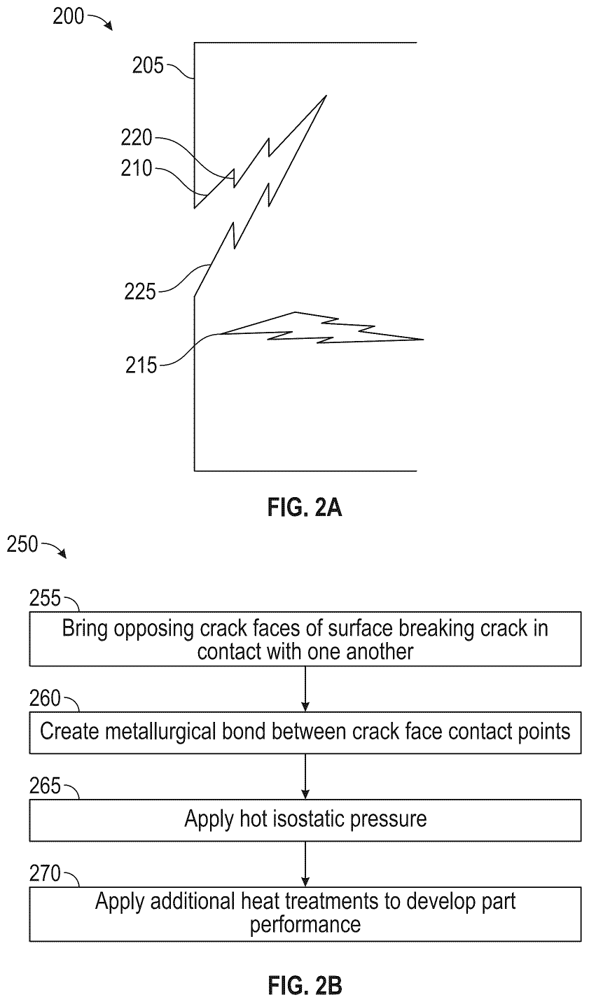

FIG. 2A illustrates an exemplary metal part 200, including an internal crack 210 connected to the surface 205 of the part 200 and an internal crack disconnected to the surface 210. The internal crack surface 220, and opposing surface 225 are further illustrated. The embodiments disclosed herein can effectively heal (e.g. close) such cracks. It should be appreciated that the metal part 200 can comprise any two or three dimensional part, and that the two dimensional illustrations provided herein are used for simplicity.

FIG. 2B illustrates steps associated with a method 250 for healing a crack in a metal part, in accordance with the disclosed embodiments. First, at step 255, opposing crack faces of surface breaking cracks in the part can be brought into contact with one another. Referring to FIG. 2A, this step could comprise bringing face 220, and face 225 of crack 205 into contact. Next, at step 260, a metallurgical bond between the crack faces is formed at the contact points of the respective faces.

Once the metallurgical bond is created, at step 215, Hot Isostatic Pressure (HIP) heat treatments can be applied to bring the remaining faces of the crack into contact. This can further eliminate volumetric defects like open cracks, and pores are closed through the application of isostatic pressure and heat.

Finally, in certain embodiments an optional application of other heat treatments can be applied at step 220 to develop part performance based on the alloy. In certain embodiments, this can comprise solid solution strengthening, precipitation strengthening, etc. Step 220 is optional because the development of part performance may differ among different materials, applications, and part make up.

There are various means by which the opposing crack faces of the surface breaking cracks in the part can be brought together. In various embodiments, the step 205 could be performed at different temperatures, rates of heating, and atmospheres to achieve crack contact and subsequent metallurgical bonding at step 210. It should be appreciated that one or more of the disclosed methods for bringing opposing crack faces of the surface breaking cracks together can be used, alone or in combination, in accordance with the disclosed embodiments.

For example, in certain embodiments, the part can be heated to induce contact between surface breaking cracks. By heating the part thermal expansion, relief of stress, or phase change can bring opposing faces of the crack in contact.

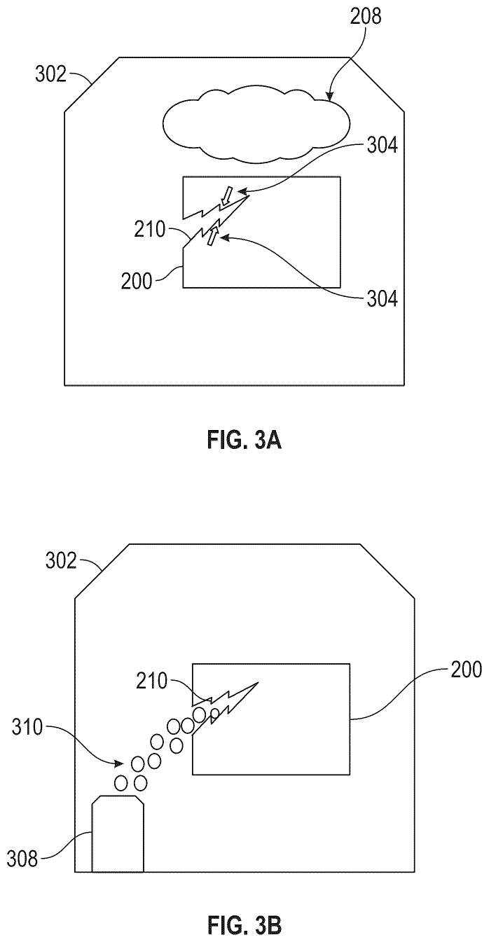

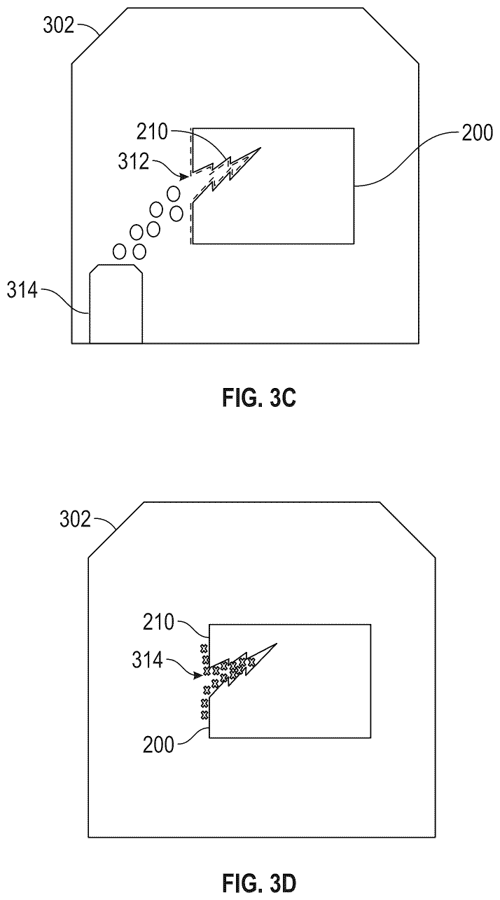

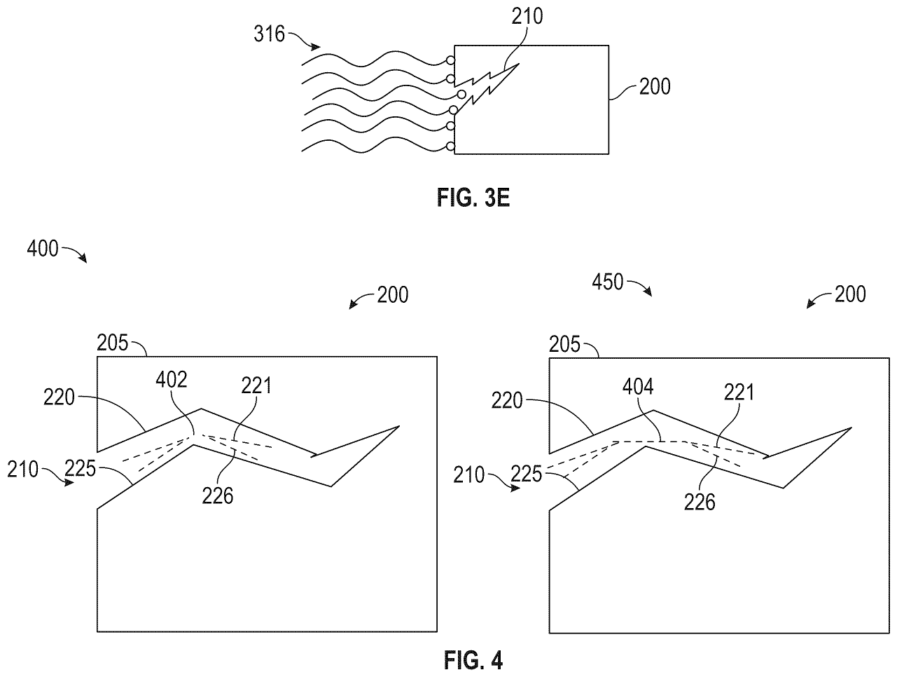

FIG. 3A illustrates a furnace 302 used to heat the part 200. As illustrated, the thermal expansion, relief of stress, or phase change can bring the opposing faces of the crack 210 in contact, as illustrated by arrows 304.

Likewise, during the heat treatment, heating the part can be used to induce surface diffusion and or evaporation/condensation mechanisms, enabling opposing faces of the crack to come into contact. In certain embodiments, varying surrounding atmospheric conditions can be applied to accelerate the surface diffusion and or evaporation/condensation mechanisms during heat treatment. In certain embodiment, a vacuum can be applied. In other embodiments, partial atmospheric pressure can be used. In other embodiments, the surrounding environment can be filed with reactive gases and held at a desired atmospheric pressure.

FIG. 3A further illustrates a reactive gas 306 provided in a furnace 302 held at a desired atmospheric pressure. The desired atmospheric pressure of reactive gas 306 induces surface diffusion and or evaporation/condensation mechanisms, enabling opposing faces of the crack to come into contact.

FIG. 3B illustrates an external evaporative source 308, provided in a furnace 302. As illustrated, evaporation 310 from the external evaporative source can penetrate the surface opening of the crack 210.

In further embodiments, vaporization and/or condensation of other alloying species or coatings from a source external to the part can be applied to the part to bring opposing faces of the crack in contact. For example, an alloying species or coating can be applied on the surface of the part and associated surfaces of the crack (via physical vapor deposition or thin film deposition, anodization for example). In other embodiments, the coating can comprise be any type of metal or oxide coating. The surface treatment allows the crack faces to come in contact.

FIG. 3C illustrates a coating 312 applied via a vaporization or condensation source 314 applied to the faces of the crack 210. The surface treatment allows the crack faces to come in contact.

In additional embodiments, heat treatment can be used to cause surface reactions such as oxidation, carburization, nitriding to bring the two faces of the crack into contact. The atmospheric conditions in the furnace used to provide the heat treatment will drive such reactions. As such, in certain embodiments, the atmospheric pressure and atomic makeup can be selected to foster oxidation, carburization, and/or nitriding to bring the two faces of the crack into contact.

FIG. 3D illustrates oxidation 314 along the surface of the crack 210, in furnace 302. The oxidation 314 (or equivalently carburization, and/or nitriding) is used to bring the two faces of the crack into contact.

In another example, application of a compressive force on the surface of the part (applied at any temperature) can be used to bring the crack surfaces together. In an exemplary embodiment, single or multiple stress fields can be applied at the exterior surface of the part via grit blast, shot blast, dry ice blast, burnishing and/or laser shock processing. It should be appreciated that, in other embodiment, other methods that plastically deform the surface can be used for the application of the compressive force on the surface of the part.

FIG. 3E illustrates the application of a stress field 316, to the surface of part 200 and the surface breaking crack therein. The stress field can comprise a grit blast, shot blast, dry ice blast, and/or laser shock processing, used to bring the crack surfaces together.

Upon completion of step 205, the opposing faces of the crack have been brought into intimate contact. In some cases, the contact may be limited to one or a few points of contact between the respective faces. The objective of step 210 is to grow and strengthen this contact point or points.

In many cases, the contact point may be a sharp concave interface. Growth of that contact point at step 210 occurs by reducing the surface energy at the contact point by reducing the radius of curvature at the contact point by diffusive mass transport. The mechanisms for this step may be to the initial phase of sintering and can include surface mass transport through evaporation and condensation mechanisms, surface diffusion, and volumetric diffusion; and bulk mass transport through grain boundary and volumetric diffusion.

As such, step 210 can be performed at a selected temperature, and selected surrounding environment, where diffusion mechanisms are active, and stress inducing, or other deleterious phase changes (incipient melting at the contact point) do not occur.

Furthermore, if step 205 is performed at a selected temperature and/or atmospheric pressure and composition, step 210 may be performed at the same or different temperature and/or atmospheric pressure and composition. In particular, it is not necessary to cool the part to room temperature between step 205 and step 210.

The amount of time spent at a selected temperature at step 210 serves to grow the width of the contact point between the crack surfaces. FIG. 4 illustrates the progression in of the crack 210 in view 400, to the crack 210 as the contact point 402 expands in view 450 at step 210. As illustrated in view 400, during step 205, the original surface 220 and surface 225 of the crack 210, are moved toward each other forming new surface 220 position 221 and new surface 225 position 226, along with contact point 402. During step 210, original surface 220 and surface 225 of the crack 210, are moved further toward each other forming new surface 220 position 221 and new surface 225 position 226, along with expanded contact point 404 between the respective surfaces of the crack 210.

The width of the contact point 404 (and associated time spent at the selected temperature) is chosen such that the contact is sufficient to withstand the pressure during subsequent steps (e.g. HIP), any thermal strain, and strain caused by phase changes during cooling. As the contact point grows, the radius of curvature at the contact point reduces.

It should be appreciated that, with sufficient time at step 205, it is possible that the contact point extends to the surface of the part. For this reason, in some cases, application of a compressive force from the surface of the (e.g. via single or multiple stress fields at the exterior surface of the part (grit blast, shot blast, dry ice blast, laser shock processing, or the like)) is preferrable because this option can create contact points between the faces of the crack at the surface of the part.

The method 200 proceeds to hot isostatic pressing at step 215. In an exemplary embodiment, hot isostatic pressing at step 215 comprises exposing the part 200 to a heat treatment cycle at high pressure. The heat treatment cycle includes holding the temperature of the environment surrounding the workpiece at a selected temperature range while simultaneously holding the gas pressure of the environment surrounding the workpiece at a pressure of at least 100 MPa. The temperature can be reduced, and the workpiece can be removed from the hot isostatic pressing machine.

With all cracks in the part sealed from the outside, or at least in contact at various points, HIP can be effectively used to close the remaining internal cracks, provided sufficient temperature and pressure are applied such that the material can flow, and any gasses, oxides, etc. can be effectively dissolved or distributed in order to avoid performance degradation.

At step 220, additional heat treatments can be applied to the part as necessary to develop the part performance. Additional heat treatments can be selected based on the purpose of the part, the material of the part, as well as the method of manufacturing the part.

It should be appreciated that the methods disclosed herein can be applied to any metal alloy part that experiences a degree of microcracking that becomes surface breaking. This can include, but is not limited to, parts produced by additive manufacturing, casting, welding, and the like.

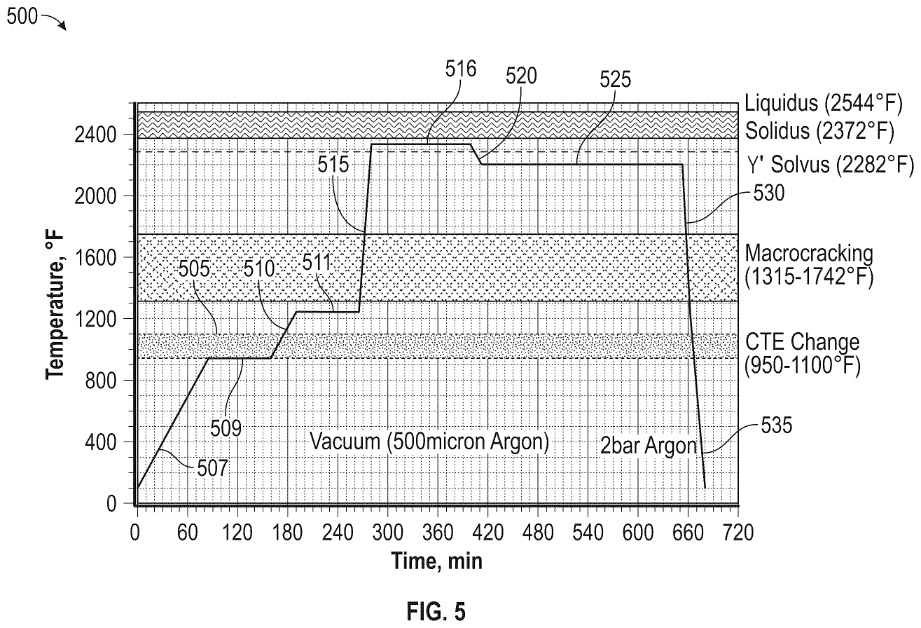

FIG. 5 illustrates a treatment cycle 500 in accordance with the disclosed embodiments. The method illustrated for treatment cycle 500 is ideal for lightly cracked parts for applications where some amount of residual porosity is acceptable. The treatment cycle 500 starts with a heat treatment at 505. The heat treatment can be conducted in a vacuum furnace at a partial pressure of 500±200 mTorr of argon for the duration of the process.

The heat treatment at 505 can comprise a temperature ramp 507 from a temperature below 150° F. to 955±15° F. In certain embodiments, the temperature ramp can occur at a programmed rate of approximately 10° F./min. In other embodiments, the temperature ramp can occur at a rate of up to 75° F./min. Next, a hold 509 can be initiated for 75±15 minutes.

Next, a second temperature ramp 510 occurs. Temperature ramp 510 can proceed at a rate of approximately 10° F./minute to 1247±15° F. In other embodiments, the temperature ramp can occur at a rate of up to 75° F./min. Once the temperature is reached a second hold 511 is administered for 75±15 minutes.

At the end of the second hold 511, the heat treatment 505 can include a third temperature ramp 515 to 2335±15° F. The third temperature ramp 515 can proceed at a rate of at least 75° F./min. Once the target temperature is reached, a third temperature hold 516 is administered for 120±15 minutes.

At step 520 a down step in temperature is performed to 2192±15° F. This allows the parts and furnace to naturally cool under the partial pressure of argon. Once everything crosses the upper tolerance band, a cooling hold 525 is administered at 2192±15° F. for 240±15 minutes.

Next an argon quench 530 can be applied at nominally 2 bar Argon at 135° F./min or faster, to 1472° F. The method concludes by a final cooling step 535, which can be completed at 1472° F., at any rate of cooling. The process 500 works to heal cracks without a typical HIP cycle, and is therefore particularly applicable for materials that can tolerate some level of porosity.

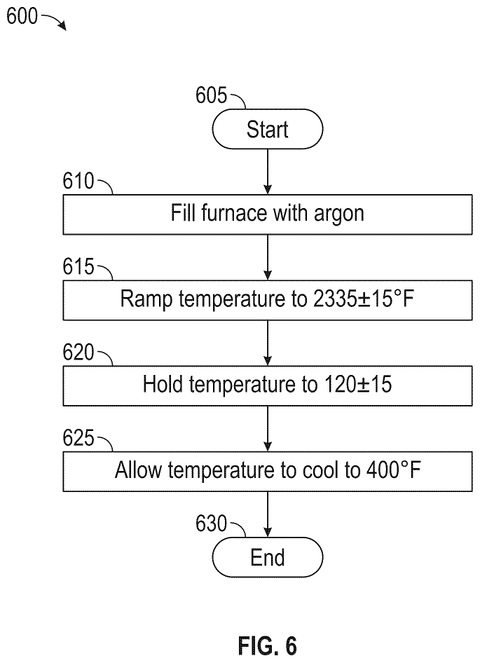

FIG. 6 illustrates steps associated with a general method for treating a work piece. The method starts at step 605. At step 610 a vacuum furnace can be filled with argon, at a partial pressure of 400±100 mTorr of argon. The partial pressure of 400±100 mTorr of argon can be held for the duration of heating, holds, and furnace cooling cycles of the method 600. At step 615, temperature in the vacuum furnace is ramped from Below 150° F. to 2335±15° F. The temperature ramp can be performed at a rate of 10° F./min. In other embodiments, the temperature can occur at a rate of up to 75° F./min. Once the temperature reaches 2335±15° F., at step 620 a hold for 120±15 minutes is applied. The parts and furnace are then allowed to cool under the partial pressure of argon to a temperature of 400° F. at step 625. Finally, the part may be cooled to a temperature for use, at any rate thereafter. The method ends at step 630.

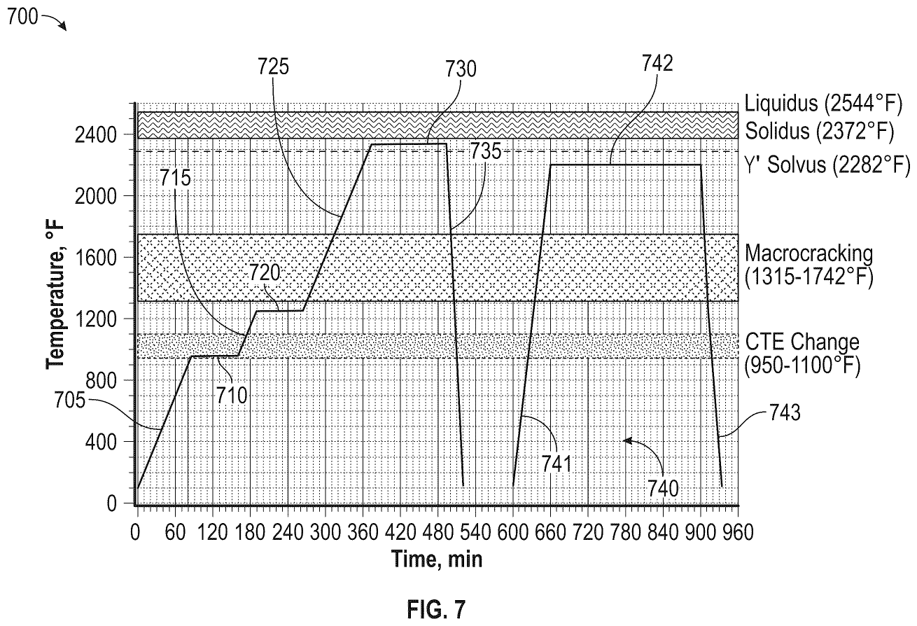

FIG. 7 illustrates another treatment cycle 700, in accordance with the disclosed embodiments. In the treatment cycle 700, the vacuum furnace can be held at a partial pressure of 500±200 mTorr of argon for the duration of heating and hold cycles. First a temperature ramp 705 is conducted from below 150° F. to 955±15° F. In certain embodiments, this first temperature ramp can be completed at a rate of 10° F./min. In other embodiments, the temperature ramp can occur at a rate of up to 75° F./min. Next a first temperature hold 710 can be applied for 75±15 minutes. A second ramp 715 is then completed at 10° F./minute to 1247±15° F. In other embodiments, the temperature ramp can occur at a rate of up to 75° F./min. A second temperature hold 720 is applied for 75±15 minutes. Next a third temperature ramp 725 can be applied with the vacuum furnace at 10° F./min to 2335±15° F. In other embodiments, the temperature ramp can occur at a rate of up to 75° F./min. A third temperature hold 730 is then applied for 120±15 minutes.

At the end of the third temperature hold 730 a 2 bar Argon quench 735 is applied at 135° F./min or faster rate of decline to 1472° F. Cooling can proceed at any rate below 1472° F. The first and second temperature hold points reduce thermal gradients in the part during processing.

Finally, a hot isostatic pressing (HIP) 740 can be applied to the part. This can include a HIP temperature ramp 741, maintenance of the temperature at a temperature hold 742, followed by quenching 743.

Steps associated with the treatment cycle 700 can use a partial pressure of argon in the furnace. This helps to control evaporation from surfaces, and improves crack healing from the surface. It should be appreciated that during the final hot isostatic pressing (HIP) steps the partial pressure differs. In certain embodiments, the HIP can be applied at 15K psi.

When parts are heated after printing (especially parts that experience precipitation) very fine precipitates may begin to grow. This can cause cracking to occur. This combined with further thermal gradients from heating, as well as changes in thermal expansion, can lead to cracking. Thus, there are different behaviors in an as-printed part versus that same part after heat treating. By holding just below the CTE transition point, macrocracking can be reduced. Likewise, holding just below a gamma prime precipitation point and allowing the temperature in the part to equilibrate also helps reduce macrocracking. This is reflected in the temperature holds described herein.

Based on the foregoing, it can be appreciated that a number of embodiments, preferred and alternative, are disclosed herein. In an embodiment, a method comprises bringing surfaces of at least one crack in a part into contact with one another at at least one contact point, expanding contact of the at least one contact point associated with the at least one crack, and applying hot isostatic pressure to the part. In an embodiment, bringing surfaces of the at least one crack in a part into contact with one another at at least one contact point further comprises heating the part at partial pressure. In an embodiment, bringing surfaces of the at least one crack in a part into contact with one another at at least one contact point further comprises heating the part at partial pressure in a reactive gas. In an embodiment, bringing surfaces of the at least one crack in a part into contact with one another at at least one contact point further comprises inducing at least one of oxidation, carburization, or nitriding on the part. In an embodiment, bringing surfaces of the at least one crack in a part into contact with one another at at least one contact point further comprises applying a coating to the part. In an embodiment, applying a coating to the part comprises physical vapor deposition coating. In an embodiment, applying a coating to the part comprises thin film deposition coating. In an embodiment, applying a coating to the part comprises anodizing. In an embodiment, bringing surfaces of the at least one crack in a part into contact with one another at at least one contact point further comprises directing stress fields at a surface of the part. In an embodiment, directing stress fields at a surface of the part comprises at least one of grit blasting, shot blasting, dry ice blasting, laser shock processing, and burnishing. In an embodiment, the method comprises applying a final heat treatment to the part.

In an embodiment, a method for treating a part comprises introducing, to a furnace, a partial pressure of argon, with the part therein, ramping a temperature inside the furnace to at least 940° F., holding the temperature inside the furnace for at least 1 hour, ramping the temperature inside the furnace to at least 1247° F., holding the temperature inside the furnace for at least 1 hour, ramping the temperature inside the furnace to at least 2320° F., and reducing the temperature in the furnace. In an embodiment, the method for treating a part further comprises, ramping the temperature inside the furnace to at least 2320° F. and holding the temperature inside the furnace for at least 105 minutes. In an embodiment of the method for treating a part, ramping a temperature inside the furnace to at least 940° F., further comprises increasing the temperature inside the furnace at a rate of 10° F./min-75° F./min. In an embodiment of the method for treating a part, ramping the temperature inside the furnace to at least 1247° F., further comprises increasing the temperature inside the furnace at a rate of 10° F./min-75° F./min. In an embodiment of the method for treating a part, ramping the temperature inside the furnace to at least 2320° F., further comprises increasing the temperature inside the furnace at a rate of 10° F./min-75° F./min. In an embodiment of the method for treating a part, reducing the temperature in the furnace further comprises argon quenching at a rate of at least 135° F./min. In an embodiment of the method for treating a part, the partial pressure of argon comprises a partial pressure of argon of 500±200 mTorr. In an embodiment of the method for treating a part further comprises applying hot isostatic pressure to the part in the furnace.

In an embodiment, a method for treating a part comprises introducing, to a furnace, a partial pressure of argon, with the part therein, ramping a temperature inside the furnace to at least 940° F. at a rate of nominally 10° F./min-75° F./min, holding the temperature inside the furnace for at least 1 hour, ramping the temperature inside the furnace to at least 1232° F. 10° F./min-75° F./min, holding the temperature inside the furnace for at least 1 hour, ramping the temperature inside the furnace to at least 2320° F. 75° F./min, and reducing the temperature in the furnace.

It should be appreciated that variations of the above-disclosed and other features and functions, or alternatives thereof, may be desirably combined into many other different systems or applications. It should be understood that various presently unforeseen or unanticipated alternatives, modifications, variations, or improvements therein may be subsequently made by those skilled in the art which are also intended to be encompassed by the following claims.

What is claimed is:

1. A method comprising:
bringing surfaces of at least one crack in a part into contact with one another at at least one contact point;
expanding contact of the at least one contact point associated with the at least one crack; and
applying hot isostatic pressure to the part.

2. The method of claim 1 wherein bringing surfaces of the at least one crack in a part into contact with one another at at least one contact point further comprises:
heating the part at partial pressure.

3. The method of claim 1 wherein bringing surfaces of the at least one crack in a part into contact with one another at at least one contact point further comprises:
heating the part at partial pressure in a reactive gas.

4. The method of claim 1 wherein bringing surfaces of the at least one crack in a part into contact with one another at at least one contact point further comprises:
inducing at least one of oxidation, carburization, or nitriding on the part.

5. The method of claim 1 wherein bringing surfaces of the at least one crack in a part into contact with one another at at least one contact point further comprises:
applying a coating to the part.

6. The method of claim 5 wherein applying a coating to the part comprises:
physical vapor deposition coating.

7. The method of claim 5 wherein applying a coating to the part comprises:
thin film deposition coating.

8. The method of claim 5 wherein applying a coating to the part comprises:
anodizing.

9. The method of claim 1 wherein bringing surfaces of the at least one crack in a part into contact with one another at at least one contact point further comprises:
directing stress fields at a surface of the part.

10. The method of claim 9 wherein directing stress fields at a surface of the part comprises at least one of:
grit blasting;
shot blasting;
dry ice blasting;
laser shock processing; and
burnishing.

11. The method of claim 1 further comprising:
applying a final heat treatment to the part.

12. A method for treating a part comprising:
introducing, to a furnace, a partial pressure of argon, with the part therein;
ramping a temperature inside the furnace to at least 940° F.;
holding the temperature inside the furnace for at least 1 hour;
ramping the temperature inside the furnace to at least 1247° F.;
holding the temperature inside the furnace for at least 1 hour;
ramping the temperature inside the furnace to at least 2320° F.; and
reducing the temperature in the furnace.

13. The method for treating a part of claim 12 further comprising, ramping the temperature inside the furnace to at least 2320° F.:
holding the temperature inside the furnace at for at least 105 minutes.

14. The method for treating a part of claim 12 wherein ramping a temperature inside the furnace to at least 940° F., further comprises increasing the temperature inside the furnace at a rate of 10° F./min-75° F./min.

15. The method for treating a part of claim 12 wherein ramping the temperature inside the furnace to at least 1247° F., further comprises increasing the temperature inside the furnace at a rate of 10° F./min-75° F./min.

16. The method for treating a part of claim 12 wherein ramping the temperature inside the furnace to at least 2320° F., further comprises increasing the temperature inside the furnace at a rate of 10° F./min-75° F./min.

17. The method for treating a part of claim 12 wherein reducing the temperature in the furnace further comprises:
argon quenching at a rate of at least 135° F./min.

18. The method for treating a part of claim 12 wherein the partial pressure of argon comprises a partial pressure of argon of 500±200 mTorr.

19. The method for treating a part of claim 12 further comprising:
applying hot isostatic pressure to the part in the furnace.

20. A method for treating a part comprising:
introducing, to a furnace, a partial pressure of argon, with the part therein;
ramping a temperature inside the furnace to at least 940° F. at a rate of nominally 10° F./min-75° F./min;
holding the temperature inside the furnace for at least 1 hour;
ramping the temperature inside the furnace to at least 1232° F. at a rate of nominally 10° F./min-75° F./min;
holding the temperature inside the furnace for at least 1 hour;
ramping the temperature inside the furnace to at least 2320° F. 75° F./min; and
reducing the temperature in the furnace.
